(19) United States
(12) Patent Application Publication
(10) Pub. No.: US 2002/0046179 A1
(43) Pub. Date: Apr. 18, 2002

(54) Virtual public access service

(75) Inventor: Junichi Kokudo, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/976,542

(22) Filed: Oct. 12, 2001

(30) Foreign Application Priority Data
Oct. 13, 2000 (JP) 314350/2000

(51) Int. Cl. G06F 17/60

(52) U.S. Cl. 705/51

(57) ABSTRACT

A method for offering a virtual public access service is provided, which makes it easier for mobile users to have access to a network (e.g., the Internet and/or LAN) by radio, and which makes it possible to realize faster communication than the existing public mobile telephone network. In the step (a), a contract is made by a provider of a virtual public access service, with a network owner/manager who owns and/or manages a network system that are accessible to authorized network users. The contract includes a clause that the network owner/manager gives the provider permission to place a radio access point device that forms a radio access point in the network system and to connect the radio access point to the Internet by way of the network system. The contract further includes a clause that the network owner/manager can get payment for the permission from the provider. In the step (b), a radio access point device that forms a radio access point is placed by the provider in the network system of the network owner/manager in accordance with the contract, thereby forming a virtual public network. The virtual public network allows registered users of the provider to access the Internet by way of the radio access point and the network system.

### BACKGROUND OF THE INVENTION

1. Field of the Invention

The present invention relates to a virtual public access service that provides mobile users with radio or wireless access means to networks using a small-sized zone radio system, such as ones according to the IEEE 802.11 specification and the Bluetooth specification. More particularly, the invention relates to a service method and a service system that form a virtual public network to enable mobile users to have radio access means to a network or networks, such as the Internet and intranets.

2. Description of the Related Art

Conventionally, a lot of companies possess their own computer networks (e.g., Local Area Networks (LANs) and Wide Area Networks (WANs)). These networks are often connected to the Internet. If these networks are located far from each other in a company site and connected together by way of the Internet, they are termed the Virtual Private Networks (VPNs).

Companies usually allow only their company members to utilize their Internet access service or VPN access service through their own LANs. In this case, when a person tries to utilize one of these services from the outside of their LANs, his/her access is checked at the gateway of the LANs whether or not he/she is one of the registered or authorized users. If he/she is one of the registered or authorized users, he/she can pass the gateway and utilize the desired Internet or VPN access service. However, if not, his/her access is rejected at the gateway and he/she cannot utilize these services. Thus, the LANs are protected by outsider users while they are kept accessible to the specific authorized users.

On the other hand, recently, as a communication scheme suitable to form a fast, wireless access means to LANs, several small-sized zone radio communication systems, such as the radio LAN systems according to the IEEE 802.11 specification and the Bluetooth specification, have been suggested for mobile users with mobile terminals. These small-sized zone radio communication systems makes it possible for mobile users to get fast access means to their LANs.

Conventionally, public Internet access services have been offered by using the above-described access method that allows only the authorized uses to access the LANs or one of the above-described small-sized zone radio communication systems (e.g., IEEE 802.11 or Bluetooth). However, these conventional public Internet access services have not been widely used yet by mobile users. This is because they have the following three problems.

The first problem is that the network (e.g., LAN) is closed to mobile users other than their authorized users because they are outsiders. Therefore, even if the network is configured in such a way that high-speed Internet access is possible by way of the network, the outsider users are unable to use this service by way of the network. Thus, the outsider users have to use the existing low-speed public mobile phone network to access the Internet.

Moreover, most of this type of users who necessitate a fast Internet access service are business people and therefore, they often want to use this service within a customer's office building. In this case, however, there is a possibility that they-are unable or difficult to use not only the fast Internet access service but also the existing low-speed public mobile phone network service. This is due to difficulty in propagation of radio wave within or through an office building. As a result, they are often unable to have means to access the Internet itself regardless of the possible access speed.

The second problem occurs in the following case.

Specifically, if an Internet Service Provider (ISP) tries to offer a wide-area radio network service like the existing public mobile telephone network service, it is preferred that the ISP employs one of the above-described small-sized zone communication systems (e.g., IEEE 802.11 or Bluetooth). This is because these systems have the advantages of low power consumption and easy frequency band assignment. In this case, however, the ISP needs to set up a huge number of new radio access points, arising extremely large investment cost. As a result, there is a problem that the ISP itself is extremely difficult or unable to cover the entire cost.

Also, to enable business people to make communication to access the Internet within or through an office building, which has been refereed in the explanation about the first problem, the ISP needs to ask for permission to place or set up a radio access point or points within or near the building from the organization that manages the same building. However, such permission is not easy to get. To facilitate getting the permission, it is preferred that the ISP suggests the organization an attractive condition that gives some advantage to the organizer.

The third problem is that even if a mobile user tries to get a local information content at a specific location by way of the Internet, the ISP is difficult or unable to transmit the user the desired local information content favorable to the location, unless the ISP manages the geographical or positional information of the user. To get desired geographical or positional information of the user, the ISP may utilize the existing Global Positioning System (GPS). In this case, however, the ISP must bear the cost of constituting a positioning-information managing system using a GPS satellite. As a result, the use of GPS is not a preferable way.

Additionally, if the user within an office building is located at a position the radio wave from the GPS satellite is difficult to reach, GPS is not serviceable. From the viewpoint of this disadvantage, other ways than the use of GPS are preferred.

### SUMMARY OF THE INVENTION

Accordingly, an object of the present invention is to provide a method and system for offering a virtual public access service that makes it easier for mobile users to have access to a network (e.g., the Internet and/or LAN) by radio, and that makes it possible to realize faster communication than the existing public mobile telephone network.

Another object of the present invention is to provide a method and system for offering a virtual public access service that can be realized at a comparatively low cost in equipment.

The above objects together with others not specifically mentioned will become clear to those skilled in the art from the following description.

According to a first aspect of the invention, a method for offering a virtual public access service is provided, which comprises the steps of:

(a) making a contract, by a provider of a virtual public access service, with a network owner/manager who owns and/or manages a network system which are accessible to authorized network users;

the contract including a clause that the network owner/manager gives the provider permission to place a radio access point device that forms a radio access point in the network system and to connect the radio access point to the Internet by way of the network system;

the contract including a clause that the network owner/manager can get payment for the permission from the provider; and

(b) placing, by the provider, a radio access point device that forms a radio access point in the network system of the network owner/manager in accordance with the contract, thereby forming a virtual public network;

the virtual public network allowing registered users of the provider to access the Internet by way of the radio access point and the network system.

With the method according to the first aspect of the invention, a provider of a virtual public access service makes a contract with a network owner/manager who owns and/or manages a network system which are accessible to authorized network users. Because of the clause of the contract, the network owner/manager gives the provider permission to place a radio access point device that forms a radio access point in the network system and at the same time, the provider can connect the radio access point to the Internet by way of the network system. Moreover, the network owner/manager can get payment for the permission from the provider.

In accordance with the contract, the provider places a radio access point device that forms a radio access point in the network system of the network owner/manager, thereby forming a virtual public network. The virtual public network allows registered users of the provider to access the Internet by way of the radio access point and the network system.

Accordingly, it is easier that mobile users have access to the Internet by radio using the virtual public network, where the mobile users can conduct faster communication to the Internet than the existing public mobile telephone network. This means that even if the mobile users do not have authorization to access the network system and they are located outside of their own sites, they can access the Internet.

If the mobile users have authorization to the network system of the network owner/manager, they can access the network system by way of the radio access point.

Furthermore, since the network owner/manager can get payment for the permission from the provider, the owner/manager is likely to make the above-described contract with the provider. As a result, it will be easy for the provider to place a lot of radio access points over a wide area. On the other hand, because of the easiness of placement of the radio access points, the provider can offer various useful and attractive services to many network users (e.g., registered mobile users of the provider, the authorized users of the network, non-registered users of the provider, and unauthorized users of the network) . These services are profitable. Accordingly, the provider can realize the virtual public network at a comparatively low cost in equipment.

In a preferred embodiment of the method according to the first aspect, the virtual public network allows the authorized network users to connect the network system by way of the radio access point. In this embodiment, there is an additional advantage that if the registered users of the provider have authorization to the network system of the network owner/manager (i.e., they are the authorized network users), they can access their own network system by way of the radio access point.

In another preferred embodiment of the method according to the first aspect, the provider has its own network connectable to the Internet, and the radio access point is connected to the network of the provider byway of an encryptable gateway. In this embodiment, there is an additional advantage that communication between the network of the provider and the radio access point can be performed without problems relating to security.

In a still another preferred embodiment of the method according to the first aspect, the provider offers an Internet access service by way of the radio access point to the authorized network users who have made a direct contract with the provider on the Internet access service and users who are not the authorized network users and have made a direct contract with the provider on the Internet access service. In this embodiment, there is an additional advantage that not only the authorized network users who have made a direct contract with the provider but also unauthorized network users can access the Internet by way of the radio access point.

In this embodiment, preferably, the authorized network users are accessible to the Internet by way of the radio access point and the network system, and the users who are not the authorized network users are accessible to the Internet by way of the radio access point and an encrypted gateway, where the gateway interconnects the radio access point and a network of the provider.

In a further preferred embodiment of the method according to the first aspect, the provider has a server for storing local information contents that are provided by a local information provider and that are favorable to specific locations. The local information contents are available to the registered users of the provider and the authorized network users of the network system. In this embodiment, there is an additional advantage that the registered users of the provider and the authorized network users of the network system can access a desired one of the local information contents as necessary.

In this embodiment, preferably, the local information contents are available to users who are not the authorized network users. In this case, there is an additional advantage that even the users who are riot the authorized network users can utilize the local information contents.

In this embodiment, preferably, the provider identifies the radio access point through which a user has accessed the local information contents. The provider transmits a set of the local information contents that relate to an identified location to the radio access point. In this case, there is an additional advantage the user can access the set of the local information contents that relate to the identified location of the radio access point. There is another additional advantage that the provider can transmit easily the user favorable and beneficial contents at his/her access point.

According to a second aspect of the invention, another method for-offering a virtual public access service is provided, which comprises the steps of:

(a) making a contract, by a provider of a virtual public access service, with a user in his/her place;

the contract including a clause that the user gives the provider permission to place a radio access point device that forms a radio access point in the place of the user and to connect the radio access point to the Internet;

the contract including a clause that the user can get payment for the permission from the provider: and

(b) placing, by the provider, a radio access point device that forms a radio access point in the place of the user in accordance with the contract, thereby forming a virtual public network;

the virtual public network allowing registered users of the provider including the user that made the contract to access the Internet by way of the radio access point.

With the method according to the second aspect of the invention, the steps are substantially the same as those of the method according to the first aspect of the invention except that the network owner/manager who owns and/or manages a network system is replaced with the user in his/her place. Therefore, there are substantially the same advantages as those of the method of the first aspect.

In a preferred embodiment of the method according to the second aspect, the provider has its own network connectable to the Internet, and the radio access point is connected to the network of the provider by way of an encryptable gateway. In this embodiment, there is an additional advantage that communication between the network of the provider and the radio access point can be performed without problems relating to security.

In another preferred embodiment of the method according to the second aspect, the provider has a server for storing amusement contents that are provided by an amusement contents provider. The amusement contents are available to the user and other registered users of the provider. In this embodiment, there is an additional advantage that the user and the registered users of the provider can access a desired one of the amusement contents as necessary.

According to a third aspect of the invention, a system for offering a virtual public access service is provided, which comprises:

(a) a network system of a network owner/manager accessible to authorized network users;

the network system including a radio access point device that forms a radio access point in the network system;

the radio access point being connectable to the Internet by way of the network system; and

(b) a provider network mounted by a provider of a virtual public access service;

the provider network being connectable to the Internet;

the provider network including a local information contents server and an authentication device;

the provider network constituting a virtual public network along with the network system;

the virtual public network allowing registered users of the provider to access the Internet by way of the radio access point and the network system.

With the system according to the third aspect of the invention, the provider network constitutes the virtual public network along with the network system that allows registered users of the provider to access the Internet by way of the radio access point and the network system.

Accordingly, it is easier that mobile users have access to the Internet by radio using the virtual public network, where the mobile users can conduct faster communication to the Internet than the existing public mobile telephone network. This means that even if the mobile users do not have authorization to access the network system and they are located outside of their own sites, they can access the Internet.

If the mobile users have authorization to the network system of the network owner/manager, they can access the network system by way of the radio access point.

Furthermore, if the network owner/manager gets payment for the permission to place the radio access point device in the network system from the provider, the owner/manager is likely to make the above-described contract with the provider. As a result, it will be easy for the provider to place a lot of radio access points over a wide area. On the other hand, because of the easiness of placement of the radio access points, the provider can offer various useful and attractive services to many network users. These services are profitable. Accordingly, the provider can realize the virtual public network at a comparatively low cost in equipment.

In a preferred embodiment of the system according to the third aspect, the provider network and the radio access point are connected to each other by way of an encryptable gateway. In this embodiment, there is an additional advantage that communication between the provider network and the radio access point can be performed without problems relating to security.

In this embodiment, preferably, the encryptable gateway includes (i) a function of judging whether or not a user who tries to access the network system or the provider network by way of the radio access point is one of the authorized network users and registered users of the provider; and (ii) a function of allowing the user to access the network system or the provider network according to result of the function (i) In this embodiment, there is an additional advantage that not only the authorized network users who have made a direct contract with the provider but also the registered users who have made a direct contract with the provider can access the Internet by way of the radio access point.

According to a fourth aspect of the invention, another system for offering a virtual public access service is provided, which comprises:

(a) a radio access point device that forms a radio access point in a place of a user; and

(b) a provider network mounted by a provider of a virtual public access service;

the provider network being connectable to the Internet;

the provider network including an amusement contents server and an authentication device;

the provider network constituting a virtual public access network along with the radio access point device;

the virtual public network allowing registered users of the provider to access the Internet by way of the radio access point and the provider network.

With the system according to the fourth aspect of the invention, the constitutional elements are substantially the same as those of the system according to the third aspect of the invention except that the network owner/manager who owns and/or manages a network system is replaced with the user in his/her place. Therefore, there are substantially the same advantages as those of the system of the third aspect.

In a preferred embodiment of the system according to the fourth aspect, the provider network and the radio access point are connected to each other by way of an encryptable gateway. In this embodiment, there is an additional advantage that communication between the provider network and the radio access point can be performed without problems relating to security.

In this embodiment, preferably, the encryptable gateway includes (i) a function of judging whether or not a user who tries to access the provider network by way of the radio access point is one of the registered users of the provider; and (ii) a function of allowing the user to access the provider network according to result of the function (i).

### BRIEF DESCRIPTION OF THE DRAWINGS

In order that the present invention may be readily carried into effect, it will now be described with reference to the accompanying drawings.

FIG. 1 is a conceptual diagram showing the concept of a method for offering a virtual public access service according to a first embodiment of the invention.

FIG. 2 is a functional block diagram showing the configuration of a system for offering a virtual public access service according to the first embodiment of FIG. 1.

FIG. 3 is a flowchart showing the partial flow of the method according to the first embodiment of FIG. 1, in which the type of the requested access services is discriminated by the service type discrimination means.

FIG. 4 is a flowchart showing the partial flow of the method according to the first embodiment of FIG. 1, in which the requested LAN access service is authenticated and gated by the authentication and gateway means for the LAN access service.

FIG. 5 is a flowchart showing the partial flow of the method according to the first embodiment of FIG. 1, in which the requested Internet access service is authenticated and gated by the authentication and gateway means for the Internet access service.

FIG. 6 is a flowchart showing the partial flow of the method according to the first embodiment of FIG. 1, in which the requested local contents server access service is authenticated and gated by the authentication and gateway means for the local contents server access service.

FIG. 7 is a functional block diagram showing the configuration of a system for conducting a method for offering a virtual public access service according to a second embodiment of the invention.

### DETAILED DESCRIPTION OF THE PREFERRED EMBODIMENTS

Preferred embodiments of the present invention will be described in detail below while referring to the drawings attached.

### First Embodiment

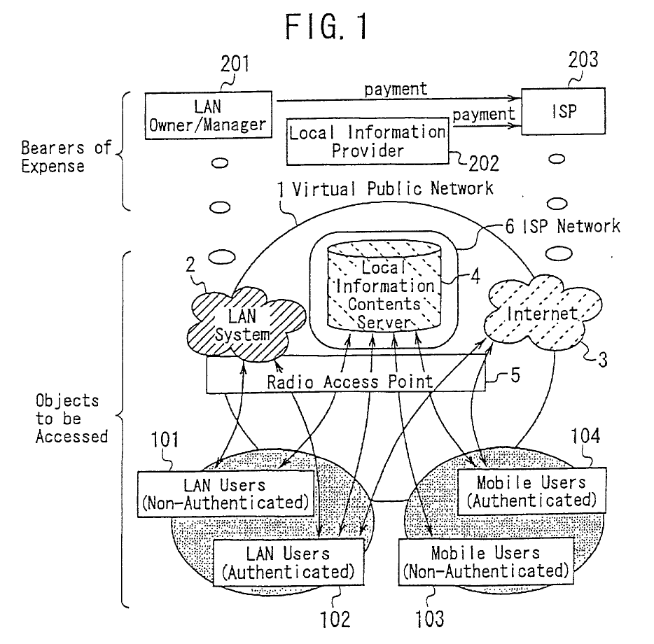

As shown in FIG. 1, a method for offering a virtual public access service according to a first embodiment uses a virtual public network 1. The network 1 comprises a LAN system (i.e., self-supported LAN system) 2 owned and/or managed by its LAN owner/manager 201, a radio access point 5 placed in the LAN system 2, and the well-known Internet 3. A local information contents server 4 for storing local information contents is provided in the network 1.

This service method comprises the LAN owner/manager 201, a local information provider 202 who provides the local information contents stored in the server 4, and an Internet Service Provider (ISP) 203 who provides an Internet access service to the Internet 3 to registered users. They are bearers of expense in this service. The virtual public access service is offered by the ISP 203 in such a way that limited users can use this service. The limited users are as follows:

The limited users who can use the service by way of the network 1 are typically divided into four groups; i.e., non-authenticated LAN users 101, authenticated LAN users 102, non-authenticated mobile users 103, and authenticated mobile users 104.

The non-authenticated LAN users 101 have authorization of the LAN system 2 but have no authentication (i.e., registration) of the ISP 203. The authenticated LAN users 102 have authorization of the LAN system 2 and authentication of the ISP 203. For example, the users 101 and 102 are members belonging to the organization (e.g., a company) of the system 2. The users 101 and 102 can access the system 2 by radio or through wire.

The non-authenticated mobile users 103 have no authorization of the LAN system 2 and no authentication of the ISP 203. The authenticated mobile users 104 have no authorization of the LAN system 2 and authentication of the ISP 203. For example, the users 101 and 102 are outsiders of the organization (e.g., a company) of the LAN system 2 while they are moved into the service range of the system 2. The users 103 and 104 cannot access the system 2; however they can access the virtual public network 1 (i.e., the local information contents server 4 and the Internet 3) by radio through the radio access point 5.

The authenticated LAN or mobile users 102 or 104 are users who have made direct contracts with the ISP 203 to use its service individually. The non-authenticated LAN or mobile users 102 or 104 are users who have not made such contracts.

The following services are available to these users 101, 102, 103, and 104 using the network 1.

Specifically, the non-authenticated LAN users 101 can access the LAN system 2 and the local information server 4. The authenticated LAN users 102 can access the system 2, the server 4, and the Internet 3. The non-authenticated mobile users 103 can access only the server 4. The authenticated mobile users 104 can access the server 4 and the Internet 3.

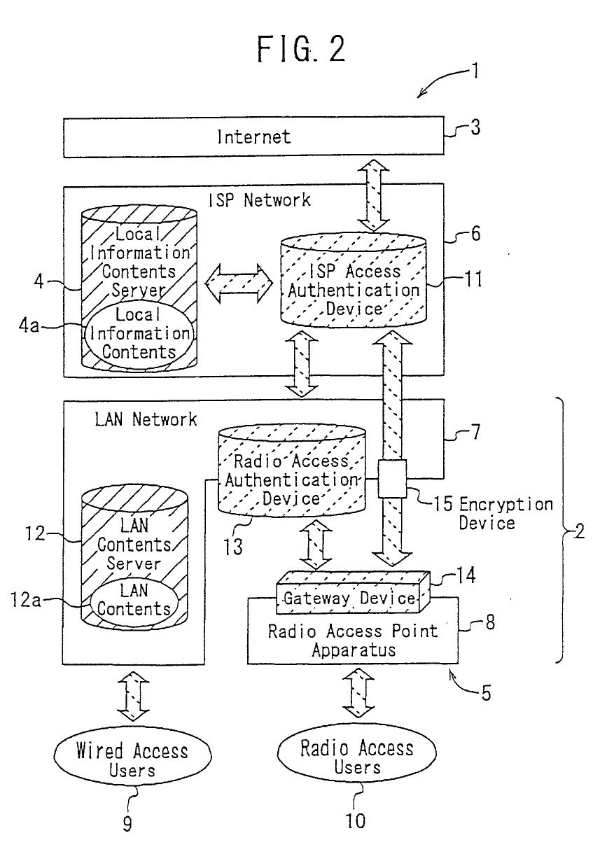

FIG. 2 shows a functional block diagram of the system that performs the method for offering a virtual public access service of the first embodiment.

As seen from FIG. 2, the virtual public network 1 comprises the Internet 3, the ISP network 6 constituted and managed by the ISP 203, the LAN system 2 constituted and managed by the LAN owner/manager 201, and a radio access point apparatus 8 that forms the radio access point 5. The apparatus 8 is located in the system 2. The Internet 3 is formed by interconnecting the computer or communications networks of worldwide ISPs to each other.

The ISP network 6 is a communications or computer network possessed by the ISP 203, which makes it possible to offer its customers access means to the Internet 3 and/or the Virtual Private Network (VPN) that connects the network 6 to the customer's communications or computer network, and/or to its contents service. The local information contents server 4 for storing the local information contents 4a provided by the local information provider 202 is placed in the network 6.

The self-supported LAN network 7 is a communications or computer network possessed and managed by the LAN owner/manager 201 to interconnect its host computers mounted in the sites of the owner/manager 201 with each other. The owner/manager 201 is usually an organization such as a company or corporation.

The ISP 203 makes a contract with the LAN owner/manager 201 and offers the virtual public access service to the owner/manager 201. This contract includes a clause that the owner/manager 201 gives the ISP 203 permission to place the radio access point apparatus 8 that forms the radio access point 5 in the LAN system 2 and to connect the radio access point 5 to the Internet 3 by way of the system 2. The contract further includes a clause that the owner/manager 201 can get payment for the permission from the ISP 203.

In accordance with the contract, the ISP 203 placed the radio access point apparatus 6 to form the radio access point 5 in the LAN system 2.

To confirm or check whether or not an accessing person is one of the allowed members of the virtual public access service the ISP 203 offers (i.e., whether or not an accessing person has an authorization of the ISP 203), an ISP access authentication device 11 is provided in the ISP network 6. Similarly, to confirm or check whether or not an accessing person is one of the allowed members of the LAN system 2 (i.e., whether or not an accessing person has an authorization of the system 2), a radio access authentication device 13 is provided in the system 2.

The radio access point apparatus 8 that forms the radio access point 5, which is mounted in the LAN system 2, includes a gateway device 14. The device 14 is used to check or identify what authority an accessing user to the virtual public access service has. This operation of the device 14 is conducted as follows:

The device 14 makes an inquiry to the radio access authentication device 13 in the LAN network 7 and the ISP access authentication device 11 in the ISP network 6, identifying the authority of the user. Then, the device 14 assigns an appropriate route to the user's access according to the authority thus identified. Thus, the device 14 allows the user to access the ISP network 6 or the LAN network 7, or rejects the user's access itself

The gateway device 14 is configured in such a way that a user trying to access the virtual public network 1 by way of the radio access point 5 is unable to operate or control the device 14 intentionally. Therefore, the network 7 is protected from invasion by outsiders. However, the device 14 always allows the user to access the ISP network 6 only.

An encryption device 15 is mounted on the communication path that interconnects the radio access point apparatus 8 with the ISP network 6. The device 15 enables the ISP 203 to conduct encrypted communication through the path. Thus, the ISP 203 can protects the data transmitted between the apparatus 8 and the network 6 against outsider's peeping. In other words, the ISP 203 can maintain privacy of the data transmitted.

As shown in FIG. 2, wired access users 9 are accessible thorough wire to the LAN network 7 of the LAN system 2 while radio access users 10 are accessible by radio to the radio access point 5. The wired access users 9 are typically the non-authenticated LAN users 101 and the authenticated LAN users 102. The radio access users 10 are typically the non-authenticated mobile users 103 and the authenticated mobile users 104. However, the LAN users 101 and 102 may be the radio access users 10 and the mobile users 103 and 104 may be the wired access users 9.

The above-described configuration of the virtual public network 1 offers the users 9 and 10 the following radio access services:

(1) For the LAN users 101 and 102, the access to the LAN network 7 (i.e., the LAN system 2) by way of the radio access point 5 is allowed by way of the radio access authentication device 13 mounted in the network 7. Thus, the users 101 and 102 can receive or use the service that makes it possible to connect the network 7 to access the LAN contents 12a stored in the LAN contents server 12 mounted in the network 7.

(2) For the users 102 and 104 having their contracts with the ISP 203 to connect the Internet 3 (i.e., having their registrations of the ISP 203), the following service is offered.

Specifically, when the users 102 or 104 try to access the Internet 3, their access is checked by the ISP access authentication device 11 in the ISP network 6 by way of the gateway device 14 in the radio access point apparatus 8. If the access is allowed by the device 11, the user 102 or 104 can connect the Internet 3 safely. This is because data transmission between the apparatus 8 and the network 6 is encrypted by the encryption device 15.

(3) For all the radio access users 10, which include not only the LAN and mobile users 101, 102, 103 and 104 but also other users having no authority to access the networks 6 and 7, their access to the local information contents 4a provided in the ISP network 6 is always allowed. This allowance is independent of their authorities to access to the ISP network 6. In other words, this allowance is issued even if the user has no authority to access the network 6.

In the above-described service system, only one radio access point 5 is formed in the LAN system 2. However, this is for the sake of simplification of description. Actually, many radio access points are provided in private network systems (e.g., LANs and WANs) over a wide area as necessary in the same way as explained here. Therefore, the virtual public network 1, which uses one of the small-sized zone radio systems, will spread wide.

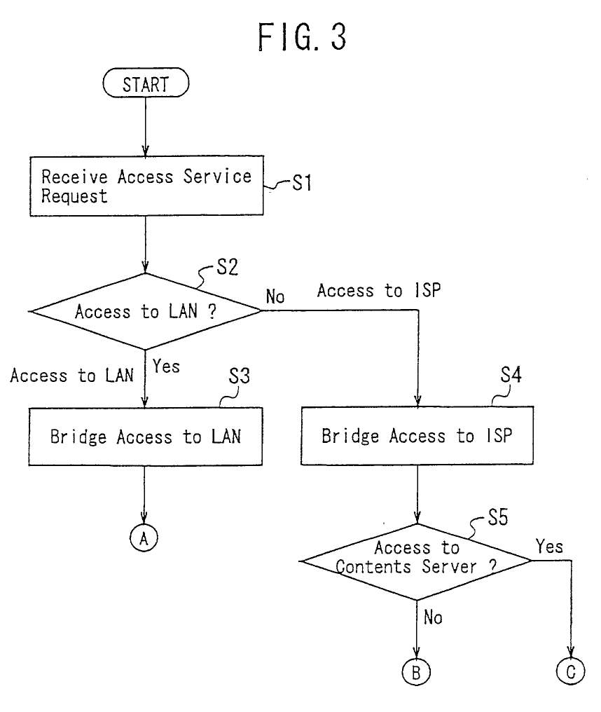

Next, the operation of the system according to the first embodiment of FIG. 2 is explained in detail with reference to FIGS. 3 to 6 below.

FIG. 3 shows the operation of the radio access point apparatus 8 that serves as discriminator of the type of access service request from a user.

As shown in FIG. 3, when the radio access point apparatus 8 receives a request for access service from one of the radio access users 10 (Step S1), the apparatus 8 judges whether the request is for the “LAN access service” to the self-supported LAN network 7, or for the “Internet access service” to the Internet 3, or for the “local information contents access service” to the local information contents 4a in the ISP network 6 (Step S2).

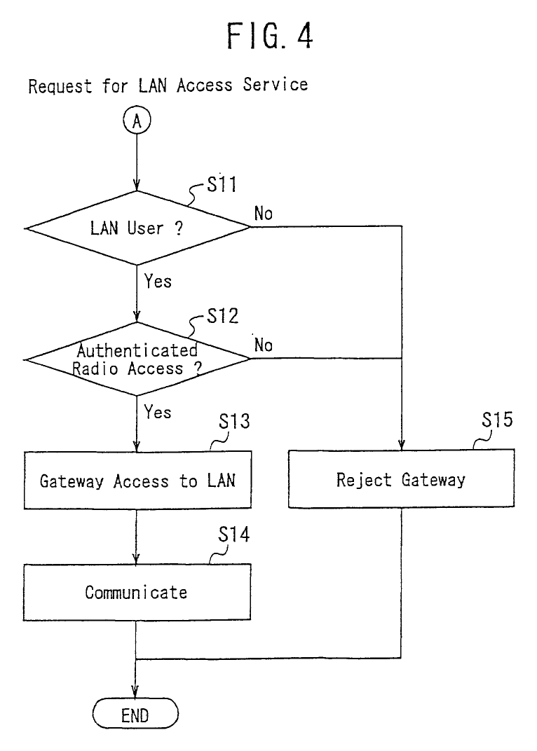

If the request is for the “LAN access service” in the Step S2, the apparatus 8 bridges the access of the user 10 toward the LAN network 7 by way of the LAN bridge device (not shown) (Step S3). Then, the flow is jumped to the Step S11 in FIG. 4.

On the other hand, if the request is for the “Internet access service” or the “local information contents access service” in the step S2, the apparatus 8 bridges the access of the user 10 toward the ISP network 6 by way of the ISP bridge device (not shown) (Step S4). Thereafter, the apparatus 8 judges whether the request is for the “Internet access service” or the “local information contents access service” (Step S5).

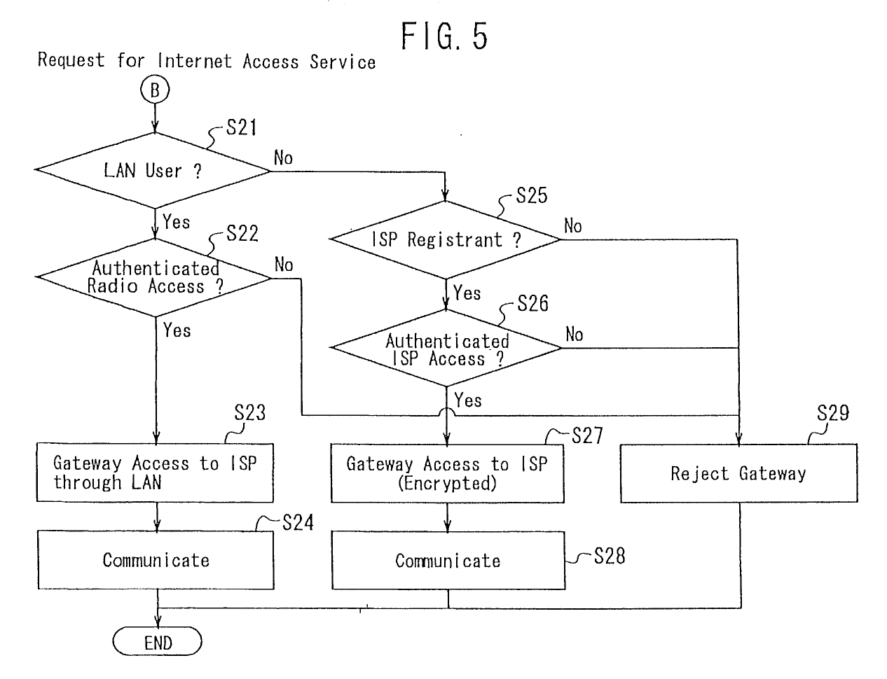

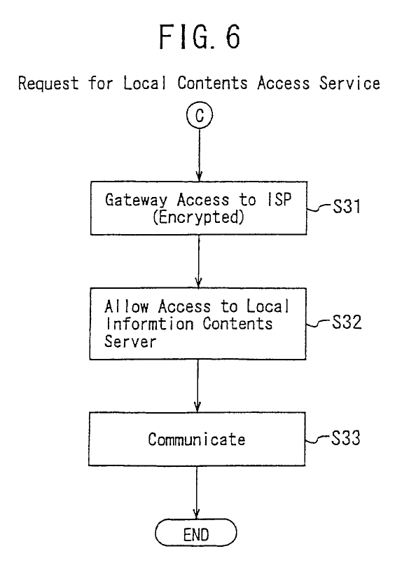

If the request is for the “local information contents access service” in the step S5, the flow is jumped to the Step S21 in FIG. 5. If the request is for the “Internet access service”, the flow is jumped to the Step S31 in FIG. 6.

Thus, these three types of the access service request are identified and divided into three different flow paths.

When the request of the wired access user 10 is for the “LAN access service”, as shown in FIG. 4, the gateway device 14 judges whether the user 10 is one of the authorized LAN users 101 and 102 (Step S11). If the user 10 is not any one of the users 101 and 102, the device 14 rejects the access or gateway (Step S15) and then, the operational flow is ended.

On the other hand, if the user 10 is one of the LAN users 101 and 102 in the step S11, the access or gateway is allowed and then, the authentication device 12 performs its operation in the step 512. In this case, the device 14 asks the device 12 whether the access is permitted or not. If the access is not permitted by the device 12, the access is rejected (Steps S15) and the flow is ended. If the access is permitted by the device 12, the user 10 can reach the LAN network 7 through the gateway device (Steps S13). As a result, the user 10 can communicate to the network 7 (Step S14).

When the request of the user 10 is for the “Internet access service”, as shown in FIG. 5, the gateway device 14 judges whether or not the user 10 is one of the LAN users 101 and 102 (Step S21) If the user 10 is not any one of the users 101 and 102, the device 14 judges whether or not the user 10 is one of the ISP-authenticated users 102 and 104 (i.e., the registrants of the ISP 203) (Step S25). If the user is not any one of the users 102 and 104, the device 14 rejects the access or gateway (Step 529) and therefore, the user 10 is unable to access the Internet 3.

On the other hand, if the user 10 is any one of the ISP-authenticated users 102 and 104 in the step S25, the gateway device 14 asks the authentication device 11 in the ISP network 6 if the user 10 has been authenticated or not (Step S26) . If the user 10 is judged to have been authenticated in the step S26, the device 14 allows the user 10 to connect the ISP network 6 by way of the encryption device 15 (Step S27). In this case, the user 10 can communicate to the Internet 3 by way of the ISP network 6 (Step S28)

If the user 10 is any one of the LAN users 101 and 102 in the step S21, the gateway device 14 asks the ISP access authentication device 11 if the user 10 has been authenticated or not (Step S22). If the user 10 is judged not authenticated in the step S22, the device 14 rejects the access of the user 10 (Step S29) and the flow is ended. If the user 10 is judged authenticated in the step S22, the device 14 allows the user 10 to connect the ISP network 6 by way of the LAN network 7 (Step S23). In this state, the user 10 can communicate the Internet 3 by way of the network 7 (Step S24).

When the request of the user 10 is for the “local information contents access service”, as shown in FIG. 6, the gateway device 14 allows any one of the users 10 to access the local information contents server 4 provided in the ISP network 6 (Steps S31, S32 and S33) At this time, the data transmission between the device 14 and the ISP access authentication device 11 is encrypted by the encryption device 15. Thus, the user 10 can always access the server 4.

With the service method according to the first embodiment of the invention, as described above, the following advantages are given.

First, the ISP 203 can get a way to collect its expense for install and maintenance of the radio access point apparatus 8 in the LAN system 2, which is required for forming the virtual public network 1 and operating the virtual public access service. This is because the ISP 203 can offer attractive and beneficial services to not only the mobile users 104 having their contracts to access the Internet 3 with the ISP 203 but also the LAN users 101 and 102 and other users having no contracts to access the Internet 3 with the ISP 203. In other words, all the services offered by the ISP 203 are profitable.

Second, if the mobile users 103 and 104 make their contracts to use the virtual public access service with the ISP 203, they can use the Internet access service by radio through the radio access point 5. This is right even if they have no authorization to access the LAN system 2 (i.e., they are not the LAN users 101 and 102). The reason of this advantage is as follows:

The authority of the user to access the Internet access service is surely discriminated by the gateway device 14 and the ISP access authentication device 11. Moreover, privacy of the data transmitted between the devices 14 and 11 is maintained by the use of the encryption device 15. Therefore, the virtual public access service including the Internet access service can be realized without arising problems relating security.

Third, all the LAN users 101 and 102 and the mobile users 103 and 104 can access the local information contents 4a in the ISP network 6 by way of the access point 5 and therefore, they can get their beneficial information from the contents 4a as necessary any time. This is independent of whether or not the user have their contracts with the ISP 203. This is because the access to the contents 4a is open to even the users 103 having no authority to access the Internet by way of the LAN network 7 or the ISP network.

Fourth, when the mobile user 103 or 104 want to get desired local information contents, he/she can get his/her desired contents favorable to his/her current location. In other words, the ISP 203 can selectively transmit the desired contents favorable to the current location of the user 103 or 104. This is possible even if the provider 203 has no system for identifying and managing the current location of the user 103 or 104 using the positional or geographical information from GPS satellites. The reason of this is as follows:

The virtual public network 1 is realized by using one of the small-sized zone radio systems and therefore, the ISP 203 can easily identify the current location of a user who tries to utilize the virtual public access service of the first embodiment. As a result, the management of the ISP 203 about the positional or geographical information of the user can be facilitated.

### Second Embodiment

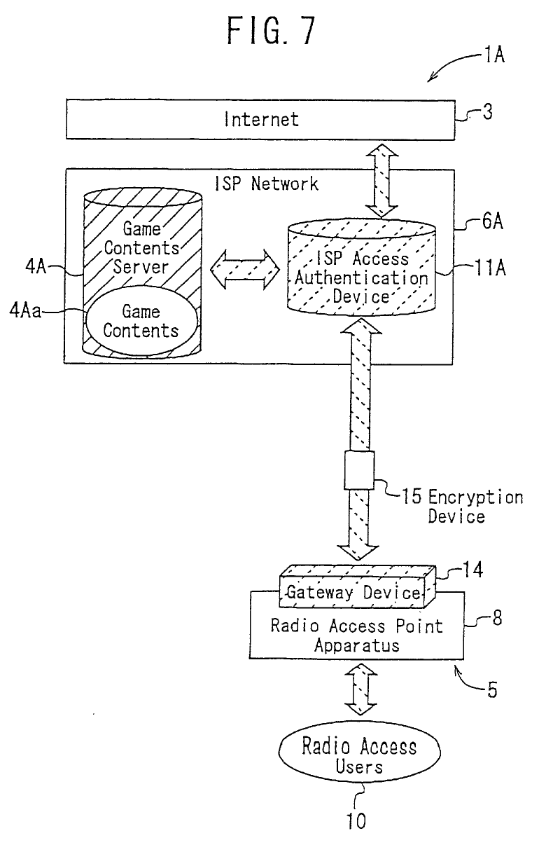

FIG. 7 is a functional block diagram of a system that performs a method for offering a virtual public access service according to a second embodiment of the invention

In the above-described first embodiment, the wireless access point 5 is provided in the self-supported LAN system 2. However, the invention is not limited to this.

Recently personal users who live in their houses have been able to be connected to the Internet using the ADSL (Asynchronous Digital Subscriber Line) or CATV (Cable TeleVision) service. In this case, the users access the Internet by way of cable modems mounted in their houses. The invention is applicable to these cases without using private network systems (e.g., LANs).

Specifically, as shown in FIG. 7, the radio access point apparatus 8 and the gateway device 14 are mounted in the house of a personal user. A virtual public network 1A comprises the Internet 3, an ISP network 6A, and the radio access point apparatus 8 that forms the radio access point 5. The ISP network 6A includes a game contents server storing specific game contents 4Aa, and an ISP access authentication device 11A. The server 4A may store local information contents like the first embodiment.

This service method of the second embodiment comprises the game contents provider (not shown) who provides the game contents 4Aa stored in the server 4A, and the Internet Service Provider (ISP) 203. They are bearers of expense in this service. The virtual public access service is offered by the ISP 203 in such a way that limited users can use this service. The limited users are radio access users 10.

With the service method of the second embodiment, it is obvious that there are approximately the same advantages as those in the method of the first embodiment.

### Variations

Needless to say, the invention is not limited to the above-described first and second embodiments. Any change may be added to these embodiments.

For example, in the above-described embodiments, the organization that offers the virtual public access service of the invention is the ISP 203. However, the invention is not limited to this case. Any private data line service provider or any public communication carrier may offer the virtual public access service.

Moreover, a conventional VPN service for interconnecting the sites of the LAN users with each other by way of encrypted communication maybe combined with the virtual public access service of the invention. In this case, a VPN radio access service can be offered.

Needless to say, any one of the small-sized zone radio systems, such as IEEE 802.11, Bluetooth, and other similar specifications that are not referred in this specification, may be applied to the invention.

While the preferred form of the present invention has been described, it is to be understood that modifications will be apparent to those skilled in the art without departing from the spirit of the invention. The scope of the present invention, therefore, is to be determined solely by the following claims.

What is claimed is:

1. A method for offering a virtual public access service, comprising the steps of:
(a) making a contract, by a provider of a virtual public access service, with a network owner/manager who owns and/or manages a network system which are accessible to authorized network users;
the contract including a clause that the network owner/manager gives the provider permission to place a radio access point device that forms a radio access point in the network system and to connect the radio access point to the Internet by way of the network system;
the contract including a clause that the network owner/manager can get payment for the permission from the provider; and
(b) placing, by the provider, a radio access point device that forms a radio access point in the network system of the network owner/manager in accordance with the contract, thereby forming a virtual public network;
the virtual public network allowing registered users of the provider to access the Internet by way of the radio access point and the network system.

2. The method according to claim 1, wherein the virtual public network allows the authorized network users to connect the network system by way of the radio access point.

3. The method according to claim 1, wherein the provider has its own network connectable to the Internet, and the radio access point is connected to the network of the provider by way of an encryptable gateway.

4. The method according to claim 1, wherein the provider offers an Internet access service by way of the radio access point to the authorized network users who have made a direct contract with the provider on the Internet access service and users who are not the authorized network users and have made a direct contract with the provider on the Internet access service.

5. The method according to claim 4, wherein the authorized network users are accessible to the Internet by way of the radio access point and the network system, and the users who are not the authorized network users are accessible to the Internet by way of the radio access point and an encrypted gateway, where the gateway interconnects the radio access point and a network of the provider.

6. The method according to claim 1, wherein the provider has a server for storing local information contents that are provided by a local information provider and that are favorable to specific locations;
and wherein the local information contents are available to the registered users of the provider and the authorized network users of the network system.

7. The method according to claim 6, wherein the local information contents are available to users who are not the authorized network users.

8. The method according to claim 6, wherein the provider identifies the radio access point through which a user has accessed the local information contents;
and wherein the provider transmits a set of the local information contents that relate to an identified location to the radio access point.

9. A method for offering a virtual public access service, comprising the steps of:
(a) making a contract, by a provider of a virtual public access service, with a user in his/her place;
the contract including a clause that the user gives the provider permission to place a radio access point device that forms a radio access point in the place of the user and to connect the radio access point to the Internet;
the contract including a clause that the user can get payment for the permission from the provider; and
(b) placing, by the provider, a radio access point device that forms a radio access point in the place of the user in accordance with the contract, thereby forming a virtual public network;
the virtual public network allowing registered users of the provider including the user that made the contract to access the Internet by way of the radio access point.

10. The method according to claim 9, wherein the provider has its own network connectable to the Internet, and the radio access point is connected to the network of the provider by way of an encryptable gateway.

11. The method according to claim 9, wherein the provider has a server for storing amusement contents that are provided by an amusement contents provider, the amusement contents being available to the user and other registered users of the provider.

12. A system for offering a virtual public access service, comprising:
(a) a network system of a network owner/manager accessible to authorized network users;
the network system including a radio access point device that forms a radio access point in the network system;
the radio access point being connectable to the Internet by way of the network system; and
(b) a provider network mounted by a provider of a virtual public access service;
the provider network being connectable to the Internet;
the provider network including a local information contents server and an authentication device;
the provider network constituting a virtual public network along with the network system;
the virtual public network allowing registered users of the provider to access the Internet by way of the radio access point and the network system.

13. The system according to claim 12, wherein the provider network and the radio access point are connected to each other by way of an encryptable gateway.

14. The system according to claim 12, wherein the encryptable gateway includes
(i) a function of judging whether or not a user who tries to access the network system or the provider network by way of the radio access point is one of the authorized network users and registered users of the provider; and
(ii) a function of allowing the user to access the network system or the provider network according to result of the function (i).

15. A system for offering a virtual public access service, comprising:
(a) a radio access point device that forms a radio access point in a place of a user; and
(b) a provider network mounted by a provider of a virtual public access service;
the provider network being connectable to the Internet;
the provider network including an amusement contents server and an authentication device;
the provider network constituting a virtual public network along with the radio access point device;
the virtual public network allowing registered users of the provider to access the Internet by way of the radio access point and the provider network.

16. The system according to claim 15, wherein the provider network and the radio access point are connected to each other by way of an encryptable gateway.

17. The system according to claim 15, wherein the encryptable gateway includes
(i) a function of judging whether or not a user who tries to access the provider network by way of the radio access point is one of the registered users of the provider; and
(ii) a function of allowing the user to access the provider network according to result of the function (i).
